(19) United States
(12) Patent Application Publication
(10) Pub. No.: US 2014/0262379 A1
(43) Pub. Date: Sep. 18, 2014

(54) TANDEM CONDITIONING REELS FOR CULTIVATOR WITH BEARING SYSTEM

(71) Applicant: LANDOLL CORPORATION, MARYSVILLE, MO (US)

(72) Inventors: Donald R. Landoll, Marysville, KS (US); Phillip R. Landoll, Marysville, KS (US); Alex J. Koch, Axtell, KS (US); Richard W. Penner, Beatrice, NE (US)

(73) Assignee: LANDOLL CORPORATION, MARYSVILLE, MO (US)

(21) Appl. No.: 14/216,398

(22) Filed: Mar. 17, 2014

Related U.S. Application Data
(60) Provisional application No. 61/789,289, filed on Mar. 15, 2013.
(60) Provisional application No. 61/789,209, filed on Mar. 15, 2013.
(60) Provisional application No. 61/789,352, filed on Mar. 15, 2013.

(51) Int. Cl. A01B 29/04; A01B 63/32

(52) U.S. Cl. CPC A01B 29/048; A01B 63/32
USPC 172/452; 172/552

(57) ABSTRACT

A tandem conditioning reel subsystem for use with a fully-integrated tillage implement including two modes of transportation: a working implement mode and a transportation mode, wherein the tandem conditioning reel subsystem includes trunnion bearing joint and a torsion axle arrangement which allows for superior coverage of the surface of a field.

### CROSS-REFERENCE TO RELATED APPLICATIONS

This application claims priority in U.S. Provisional Patent Application Nos. 61/789,209, filed Mar. 15, 2013, 61/789,289, filed Mar. 15, 2013 and 61/789,352, filed Mar. 15, 2013, all of which are incorporated herein by reference.

### BACKGROUND OF THE INVENTION

1. Field of the Invention

The present disclosed technology relates generally to agricultural farm equipment, and in particular to a high-speed tillage tool having soil conditioning double tandem reels, the tillage tool to be towed behind a tractor or other suitable vehicle for tilling a field or other piece of land.

2. Description of the Related Art

Tillage implements are generally towed behind tractors and can be equipped with one or more leveling reels or cylinders for conditioning and leveling the soil behind the implement during a tilling operation. The present invention relates to a tillage implement with conditioner reels adapted for raising and lowering relative to the implement frame.

Typical disc tillers and vertical tillers have the negative aspect of soil compaction unless the vehicle is operated at very low speeds. It is difficult to have high quality soil conditioning while traveling at relatively high speeds (8-12 miles per hour). Additionally, transportation of such tillage equipment can be difficult.

Heretofore there has not been available a tillage tool with the advantages and features of the disclosed subject matter.

### SUMMARY OF THE INVENTION

A fully-integrated tillage implement including two modes of transportation: a working implement mode and a transportation mode, wherein a transport wheel assembly can be hydraulically raised and lowered at will to transform the implement between the various positions. A hydraulic leveling bar affixed to the drawbar assembly serves to keep the entire implement level with the tractor while traversing a field or while towing the implement in transport mode.

The present invention features two sets of rotary disc groups, each disc being individually and independently mounted to a respective mounting assembly, and a double tandem conditioning reel assembly connected by a bearing system specifically designed to allow the conditioning reels to contour to the earth while the implement is in a working orientation. Each element of the present invention is capable of moving with response to changes in field conditions as well as the orientation of the vehicle's components, thus providing a superior high-speed tillage implement.

### BRIEF DESCRIPTION OF THE DRAWINGS

The drawings constitute a part of this specification and include exemplary embodiments of the invention illustrating various objects and features thereof, wherein like references are generally numbered alike in the several views.

FIG. 1 is an isometric perspective view of an embodiment of the present invention shown in a working configuration.

FIG. 2 is a right side elevational view thereof, the opposing elevational view being a mirror image thereof

FIG. 3 s a right side elevational view of an embodiment of the present invention shown in a transport configuration, the opposing elevational view being a mirror image thereof.

FIG. 4 is a detailed isometric view of an embodiment of a tandem conditioning reel subsystem including bearing.

FIG. 4A is a more detailed isometric view of a torsion axle component thereof.

FIG. 5 is an exploded isometric view thereof.

FIG. 6 is a top plan view thereof.

FIG. 7 is a side elevational detail view of an embodiment disc assembly subsystem.

FIG. 8 is an exploded isometric view thereof.

FIG. 9 is a detailed isometric view thereof.

FIG. 10 is a sectional isometric view thereof

FIG. 11 is a front elevational view thereof.

FIG. 12 is a front sectional view thereof.

### DETAILED DESCRIPTION OF THE PREFERRED EMBODIMENT

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning

### II. Embodiment of the Tillage Tool 2

Referring to the drawings in more detail, the reference numeral 2 generally designates a tillage tool implement to be towed by a tractor or other suitable vehicle (not shown). The tillage tool 2 is generally constructed from a frame 10, a draw bar assembly 12, a pair of transport wheel assemblies 4 and the various tilling elements. The draw bar assembly also includes a ring coupling 14 and a chain 16 for securing to a vehicle.

Each transport wheel assembly 4 is hingedly connected to the frame 10 via a hinge bar 30, and is locked into one of two positions (working position and travel position) via a hydraulic linear actuator 42.

The draw bar assembly 12 is similarly hingedly connected to the frame 10 at two hinged points 32 and is kept level by a hydraulic leveling arm 18.

A pair of conditioning reels 6 connected in tandem via a bearing 7 is preceded by a row of front discs 20 and a row of rear discs 22. Each disc is independently mounted to a leveling bar 8 via a disc mounting assembly 24. Each is also protected with an air spring 34, allowing the discs to work uneven fields with ease and without damaging a component.

The tandem conditioning reels 6 serve to better conform to uneven terrain when the tillage implement 2 is being drawn through a field. When the transport wheel assemblies 4 are raised in a “working” position, the tandem conditioning reels are placed in direct contact with the earth. When the transport wheel assemblies are lowered into a “transport” position, the conditioning reels are automatically raised away from the earth. This is diagramed in FIGS. 2 and 3 in more detail.

As shown in FIG. 3, when the implement 2 is configured in a “transport” orientation, the wheels 38 of the transport wheel assemblies 4 contact the earth, and the conditioning reels 6 are lifted. This is caused by a hydraulic linear actuator 42 lifting an arm assembly 40 which is connected to the travel wheel assembly 4. A separate hydraulic linear actuator 26 is connected to the mounting arm 31 which is connected to the bar 9 of the conditioning reels 6, and this hydraulic linear actuator 26 lifts the conditioning reels away from the surface 36. As this transformation takes place, a hydraulic level piston and cylinder 18 adjusts the leveling arm 19, which levels the draw bar assembly 12 as necessary.

The front disc 20 and rear disc 22 gangs may be alternative left and right discs as illustrated. They may be of varying sizes and designs, and they may optionally be angled. The conditioning reels 6 must follow the discs for optimum results. Additional tools, such as chisels, knives, and tines, could also be affixed behind the discs or the conditioning reels.

The tools float as the implement 2 passes over uneven areas of a field. The front and rear discs float due to the air springs 34 affixed to those assemblies. In a preferred embodiment, the air springs 34 function similar to the invention disclosed in U.S. Pat. Nos. 7,992,650 and 7,997,218 which are assigned to a common assignee to the present application and are incorporated herein by reference.

### III. Bearing System 5 for Double Tandem Conditioning Reels

Reference numeral 5 generally indicates a bearing system which utilizes two conditioning reels 6 operating in tandem, thereby increasing the ability to contour to a field's surface and increasing the coverage area of the conditioning reels. A formed side plate 7 provides an offset between the two reels, such that the reels are offset to maximize the surface area covered by the reels. This offset is built in at the angle 11 shown in FIG. 6, which separates the angled portion 13 from the leading 15 and trailing 17 ends. As shown more clearly in FIG. 4, the disc elements of the reels is offset just enough that the discs of the rear conditioning reel is located at appoint between two discs of the foremost reel.

The double tandem conditioning reels 6 increase contour cover of a field after the front 20 and rear 22 discs have worked the field. As shown in FIG. 6, the reels are joined to the formed plate 7 by bolts 52 connected to the trunnion joint ends 56 which in turn connect to the trunnion joint centerpiece 54. This entire assembly surrounds a pivot point bolt 58 in which the reels 6 are joined to the joint by a bearing 60. The end plate 59 of the reel 6 is pivotally connected to the trunnion bearing through the pivot bolt 58, and is connected to the most adjacent intermediate plate 61 with a reel axle 57. In a preferred embodiment, the axle 57 is only connected to the outer-most intermediate plate 61, but it could be conceivable to extend the axle through additional plates. This construction allows the reels to spin freely, while providing lateral flexibility parallel to the direction of travel of the implement 2. The pivot bolt 58 is accessible through an opening 55 in the plate 7.

As is true with all trunnion joints, the central element 54 provides a first level of flexibility to the reel 6, and the pivot bolt 58 passing through the trunnion joint permits the reel to rotate on its axis. The side components 56 of the trunnion joint which are mounted to the formed plate 7 provide even more flexibility to the reel against its path of travel.

Further aiding in flexibility is the torsion axle shown in FIGS. 4, 4A, and 5. The bar 9 of the double tandem system 5 is connected to the mounting arm 31 by a mounting tube 48 affixed to a pair of mounting plates 46 which are bolted to the mounting arm 31. Urethane or rubber torque tubes 50 are inserted between the bar 9 and the tube 48. These rubber tubes are flexible and allow the axle to turn slightly without spinning, thus providing flexibility to the entire double tandem system 5.

As shown in FIGS. 4 and 4A, the mounting arm 31 is bolted to the mounting plates 46 via a main mounting bolt 33 and at least two adjusting bolts 35 which are placed into adjusting bolt holes 37 depending upon the pitch of the mounting arm 31 and reels 6 as desired. A spacer 39 is also placed between the mounting plates 46 to maintain structural spacing.

IV. Disc Assembly 24 with Thrust Bearing Assembly 66

FIG. 7 generally shows a detailed elevational view of a disc assembly 24 for a front disc 20, though the rear disc 22 would feature an identical assembly. A curved mounting shank 62 joins each disc 20 to an independent body structure 64. Flexibility is given to the assembly by the air spring 34 which interfaces with the mounting shank 62 via a plate, and the thrust bearing assembly 66 which provides a rotation point for the arm. The entire concept here is to allow for the disc assembly to float in the field for superior contact with the soil, as well as to prevent damage to the disc or other equipment by allowing each disc to independently bounce over obstacles in the field such as rocks.

FIG. 8 shows a more detailed explanation of the construction of the disc assembly 24. Particularly important is the construction of the thrust bearing 66, which is generally constructed from two bearings 70 housed within a bushing bearing housing 68 and integrated with two bushing bearing inserts 74, two washers 72, and two washer backers 76. A bolt is threaded through these elements and the bearing connects the mounting shank 62 to the body 64 of the mounting assembly 24. As stated above, the air spring is described in more detail in U.S. Pat. Nos. 7,992,650 and 7,997,218 which are assigned to a common assignee to the present application and are incorporated herein by reference.

FIGS. 9-12 show additional information pertaining to the structure of the thrust bearing 66. The bolt 78 which is threaded through the components and the nut 80 which secures the bolt to the components is shown as it connects the bearing inserts 74 within the bearings 70 which are all encased in the bearing housing 68 which is manufactured from high molecular weight (HMW) plastic or a similarly suitable material capable of being weather resistant and highly resistant to wear. The bearing 66 must be capable of resisting axial forces as well as providing a pivot point for the shank 62 of the disc assembly 24.

It is to be understood that while certain aspects of the disclosed subject matter have been shown and described, the disclosed subject matter is not limited thereto and encompasses various other embodiments and aspects.

Having thus described the disclosed subject matter, what is claimed as new and desired to be secured by Letters Patent is:

1. A tandem conditioning reel subsystem for a tilling implement, the subsystem comprising:
a first conditioning reel and a second conditioning reel, each said conditioning reel including opposite ends capped by end plates, a plurality of intermediate support plates, and earth-leveling structure extending between the ends and support plates;
a formed end plate located at each end, said formed plate featuring an offset such that said first conditioning reel is offset from said second conditioning reel;
a trunnion bearing mounting each end plate to a respective formed end plate;
a central axle affixed centrally to each said formed end plate, said axle running parallel to said first and second conditioning reels; and
said first and second conditioning reels mounted to a main frame of the tilling implement via a mounting bar connecting to said central axle.

2. The conditioning reel subsystem of claim 1, further comprising:
a mounting tube bolted around said central axle;
a pair of mounting plates affixed to said mounting tube; and
said mounting arm bolted to said mounting plates;

3. The conditioning reel subsystem of claim 2, further comprising:
a plurality of torque-absorbing tubes inserted between said mounting tube and said central axle, wherein said tubes are configured to flex against rotation movement of said central axle while preventing said central axle from rotating more than 15 degrees.

4. The conditioning reel subsystem of claim 3, further comprising:
said central axle having a generally rhomboid cross-section having a generally vertical orientation such that one point of the rhombus points upward, one points downward, and the other two points generally point in a direction parallel to the direction of travel of the implement.

5. The conditioning reel subsystem of claim 1, further comprising:
a hydraulic linear actuator connected between said mounting arm and said main frame of the tilling implement;
said hydraulic linear actuator configured to raise and lower said mounting arm, thereby raising and lowering said first and second conditioning reels.

6. The conditioning reel subsystem of claim 5, further comprising:
said hydraulic linear actuator further configured to raise and lower said mounting arm between a first, working position and a second, transport position.

7. The conditioning reel subsystem of claim 1, further comprising:
said trunnion bearing including a pair of flat plates bolted to said formed end plate, each plate affixed to a respective stem stemming from a hub; and
said hub bolted to said end plate of a respective first or second conditioning reel, thereby permitting rotation of said conditioning reel.

8. The conditioning reel subsystem of claim 1, wherein the offset created by said formed end plates causes the travel path of said plurality of intermediate support plates of said second conditioning reel to correspond to the center of the travel paths of two respective intermediate support plates of said first conditioning reel.
